(19) United States
(12) Patent Application Publication
(10) Pub. No.: US 2011/0230231 A1
(43) Pub. Date: Sep. 22, 2011

(54) COMMUNICATION APPARATUS

(75) Inventors: Masahide NODA, Kawasaki (JP); Naoki Nishiguchi, Kawasaki (JP); Masatomo Yasaki, Kawasaki (JP)

(73) Assignee: Fujitsu Limited, Kawasaki (JP)

(21) Appl. No.: 13/039,437

(22) Filed: Mar. 3, 2011

(30) Foreign Application Priority Data
Mar. 19, 2010 (JP) 2010-063878

(51) Int. Cl. H04W 88/06

(52) U.S. Cl. 455/552.1

(57) ABSTRACT

A communication apparatus includes a plurality of virtual machines. The plurality of virtual machines include at least one virtual machine compliant with multiple caller number service and at least one virtual machine noncompliant with the multiple caller number service. One of the plurality of virtual machines includes a mode assignment information storage and a call mode writer. The mode assignment information storage stores mode assignment information indicating a call mode corresponding to each of the at least one virtual machine noncompliant with the multiple caller number service. The call mode indicates a caller number. The call mode writer obtains, upon receiving a call request from another virtual machine among the plurality of virtual machines, the call mode corresponding to the another virtual machine from the mode assignment information storage to write mode information specifying the obtained call mode in the received call request.

### CROSS-REFERENCE TO RELATED APPLICATION

This application is based upon and claims the benefit of priority of the prior Japanese Patent Application No. 2010-063878, filed on Mar. 19, 2010, the entire contents of which are incorporated herein by reference.

### FIELD

The embodiments discussed herein are related to a communication apparatus used for a multiple caller number service.

### BACKGROUND

In recent years, the penetration of mobile phones has been dramatically increased. The mobile phones are coming into wider use for business and personal. In this circumstance, there is a need for separation between business and personal expenses, namely, a need for a mobile phone user to divide mobile phone charge into account for business and personal expenses according to business and personal use. For the separation between business and personal expenses, for example, a company pays the mobile phone charge for business use and the user pays the mobile phone charge for personal use.

Methods for achieving the separation between business and personal expenses include, for example, a method for performing the separation and accounting for business and personal expenses on the basis of call destinations of a detailed phone bill and a method for using a plurality of mobile phones, namely, using a mobile phone for business and another mobile phone for personal. In addition, communication common carriers (hereinafter, referred to as carriers) provide services in each of which a single mobile phone is allowed to have a plurality of phone numbers for different purposes and a user of the mobile phone may use the different phone numbers. In the following discussion, the service of allowing a single mobile phone to have a plurality of phone numbers will be called “multiple phone number service”.

In the multiple phone number service, a combination of a main number and a sub-number are previously registered in a user's mobile phone. The main number indicates a primary phone number that the mobile phone or the user has. The sub-number indicates a phone number added in the multiple phone number service. When the user makes a call, the mobile phone inserts, into a phone call signal (hereinafter, referred to as a call signal) including the main number as a caller's phone number (hereinafter, referred to as a caller number), mode information indicating whether the main number or the sub-number is used as the caller number to be notified to a call destination. The mobile phone transmits the call signal including the mode information to a facility of the carrier. The facility of the carrier determines the final caller number on the basis of the main number and the mode information included in the call signal and modifies the call signal to include the final caller number to transmit the call signal to a phone of the call destination. In addition, the facility of the carrier performs, for example, a process of determining a billing destination in accordance with the final caller number. The service of allowing a single mobile phone to have a plurality of caller numbers will be called “multiple caller number service”.

According to a known technique, a mobile station is allowed to have a first operating system (OS) for performing a mobile station function and a second OS for performing an application process such that functions of the OSs are cooperated with each other. According to another known technique, a plurality of phone numbers are managed by functions of an OS and an application program installed in a mobile communication apparatus.

Japanese Laid-open Patent Publication No. 2002-501248 and Japanese Laid-open Patent Publication No. 2006-526222 disclose related techniques.

### SUMMARY

According to an aspect of the present invention, provided is a communication apparatus including a plurality of virtual machines. The plurality of virtual machines include at least one virtual machine compliant with multiple caller number service and at least one virtual machine noncompliant with the multiple caller number service. One of the plurality of virtual machines includes a mode assignment information storage and a call mode writer. The mode assignment information storage stores mode assignment information indicating a call mode corresponding to each of the at least one virtual machine noncompliant with the multiple caller number service. The call mode indicates a caller number. The call mode writer obtains, upon receiving a call request from another virtual machine among the plurality of virtual machines, the call mode corresponding to the another virtual machine from the mode assignment information storage to write mode information specifying the obtained call mode in the received call request.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an example of a multiple phone number service for a mobile phone;

FIG. 2 is a diagram illustrating an exemplary configuration of a mobile phone according to an embodiment of the present invention;

FIG. 3 is a diagram illustrating an example of mode assignment information according to an embodiment of the present invention;

FIG. 4 is a diagram illustrating an exemplary operation flow of a mode information insertion process performed by a call mode writer according to an embodiment of the present invention;

FIG. 5 is a diagram illustrating an exemplary configuration of a mobile phone according to an embodiment of the present invention;

FIG. 6 is a diagram illustrating an exemplary configuration of a mobile phone according to an embodiment of the present invention;

FIG. 7 is a diagram illustrating an example of mode assignment information according to an embodiment of the present invention; and

FIG. 8 is a diagram illustrating an exemplary operation flow of a mode information insertion process performed by a call mode writer according to an embodiment of the present invention.

### DESCRIPTION OF EMBODIMENTS

For the above-discussed multiple phone number services provided by the carriers, the specification of, for example, the mode information inserted into the call signal differs from one carrier to another. If improper information is inserted into the call signal, unintended billing may occur. Accordingly, the carriers want to avoid disclosure of these techniques.

In order to allow a mobile phone to have a function for the multiple phone number service, it is necessary to extensively change various portions of the OS of the mobile phone, for example, a user interface to select a caller number and control of access to a phone book. Accordingly, it may require a significant amount of development to make an OS noncompliant with the multiple phone number service to support the multiple phone number service.

It is therefore difficult to mount a service specific to a carrier, such as the multiple phone number service, on an “open mobile phone OS” which is showing of signs of flourishing and whose source code is open to public inspection, in terms of protection of classified information and development efficiency.

It is preferable to provide a technique for allowing a multiple phone number service, serving as a closed service specific to a carrier, to be used even by functions of a mobile phone OS that is noncompliant with the multiple phone number service.

According to the embodiments, the multiple phone number service may be used by, for example, functions of a mobile phone OS that is noncompliant with the multiple phone number service. Consequently, functions of an open mobile phone OS may use a multiple phone number service specific to a carrier, thus increasing the convenience of the user.

The embodiments will now be discussed with reference to the drawings.

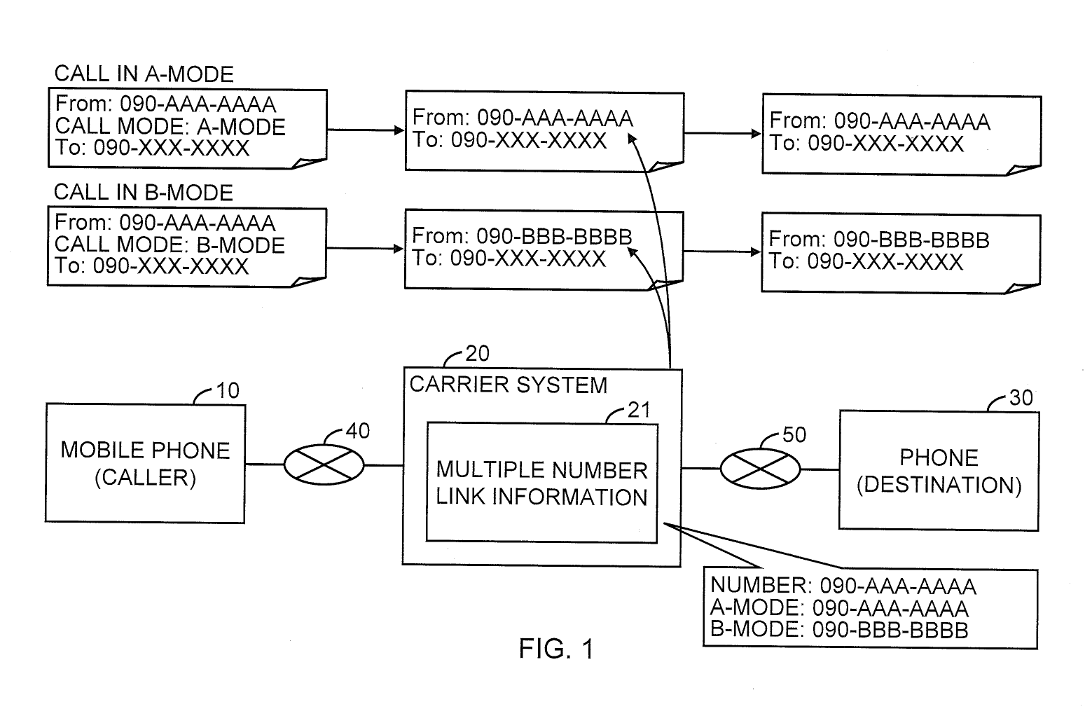

FIG. 1 illustrates an example of a multiple phone number service for a mobile phone.

Referring to FIG. 1, the mobile phone 10 is owned by a caller. The mobile phone 10 of the caller has a function for achieving the multiple phone number service provided by a carrier. A carrier system 20 is a facility of the carrier corresponding to the mobile phone 10 of the caller and provides the multiple phone number service. A phone 30 is owned by a call destination to that the caller will make a call on the mobile phone 10. The mobile phone 10 is connected to the carrier system 20 via a communication network 40 and the carrier system 20 is connected to the phone 30 via a communication network 50.

It is assumed that two phone numbers, “090-AAA-AAAA” and “090-BBB-BBBB”, are available in the mobile phone 10 of the caller. It is also assumed that the phone number “090-AAA-AAAA” is a main number and the other phone number “090-BBB-BBBB” is a sub-number. It is further assumed that a phone number of the phone 30 (also referred to as a destination phone 30) of the call destination is “090-XXX-XXXX”. The number of phone numbers available in the mobile phone 10 of the caller may be three or more for the multiple phone number service.

In the embodiments, modes classified to use different caller numbers will be termed “call modes”. To make a call on the mobile phone 10, the caller selects a call mode through a user interface of the mobile phone 10. It is assumed that a call mode in which a call is made using the main number “090-AAA-AAAA” as the caller number will be termed “A-mode” and anther call mode in which a call is made using the sub-number “090-BBB-BBBB” as the caller number will be termed “B-mode”. When making a call on the mobile phone 10, the caller selects the “A-mode” or “B-mode” as the call mode to make a call. If no mode selection is made by the user, the “A-mode” is automatically selected to make a call.

When the call is made, the mobile phone 10 performs a call with accompanying mode information specifying the call mode. At this time, the mobile phone 10 performs a call using the main number “090-AAA-AAAA” as the caller number irrespective of the selected call mode. The carrier system 20 manages and controls the caller numbers related to the respective call modes.

The carrier system 20 manages the combination of the phone numbers available in the mobile phone 10 on the basis of multiple number link information 21. Referring to FIG. 1, the phone number (main number) “090-AAA-AAAA” of the mobile phone 10 is linked to the caller number “090-AAA-AAAA” in the “A-mode” and the caller number “090-BBB-BBBB” in the “B-mode”.

The carrier system 20 refers to the multiple number link information 21 and rewrites the caller number included in a call signal received from the mobile phone 10 in accordance with the mode information included in the call signal. The carrier system 20 performs billing for each of the phone numbers related to the call modes. The destination phone 30 is notified of the caller number of the mobile phone 10 rewritten in relation to the call mode as an incoming phone number.

For example, it is assumed that the caller selects the “A-mode” as the call mode to make a call to the phone 30 on the mobile phone 10 as illustrated in FIG. 1. In this case, in a call signal transmitted from the mobile phone 10 to the carrier system 20, the main number “090-AAA-AAAA” is specified as the caller number (“From”), the “A-mode” is specified as the call mode, and the phone number “090-XXX-XXXX” of the phone 30 is specified as a destination phone number (hereinafter, referred to as a destination number) (“To”). When the call mode selected by the caller is the main number of the mobile phone 10, mode information may not be included in the call signal transmitted from the mobile phone 10 to the carrier system 20.

Since the call mode specified by the mode information included in the call signal received from the mobile phone 10 is the “A-mode”, the carrier system 20 obtains the phone number “090-AAA-AAAA” related to the “A-mode” from the multiple number link information 21. The carrier system 20 rewrites the caller number (“From”) included in the call signal received from the mobile phone 10 with the obtained phone number “090-AAA-AAAA”. In this case, since the “A-mode” is the call mode using the main number, the caller number does not change before and after rewriting. Then, the carrier system 20 removes the mode information from the call signal. The carrier system 20 performs billing for this call using the phone number “090-AAA-AAAA” related to the “A-mode”.

The phone 30 receives the call signal including the phone number “090-AAA-AAAA” related to the “A-mode” as the caller number (“From”).

For example, it is assumed that the caller selects the “B-mode” as the call mode to make a call to the phone 30 on the mobile phone 10 as illustrated in FIG. 1. In this case, in a call signal transmitted from the mobile phone 10 to the carrier system 20, the main number “090-AAA-AAAA” is specified as the caller number (“From”), the “B-mode” is specified as the call mode, and the phone number “090-XXX-XXXX” of the phone 30 is specified as the destination number (“To”).

Since the call mode specified by the mode information included in the call signal received from the mobile phone 10 is the “B-mode”, the carrier system 20 obtains the phone number “090-BBB-BBBB” related to the “B-mode” from the multiple number link information 21. The carrier system 20 rewrites the caller number (“From”) included in the call signal received from the mobile phone 10 with the obtained phone number “090-BBB-BBBB”. Then, the carrier system 20 removes the mode information from the call signal. The carrier system 20 performs billing for this call using the phone number “090-BBB-BBBB” related to the “B-mode”.

The phone 30 receives the call signal including the phone number “090-BBB-BBBB” related to the “B-mode” as the caller number (“From”).

In the embodiments, it is assumed that the multiple phone number service provided by the carrier is performed in the above-discussed manner.

Mobile phone techniques according to the embodiments, for allowing calls using multiple phone numbers to be performed even by functions of an open mobile phone OS that is noncompliant with the multiple phone number service, will be discussed below.

### First Embodiment

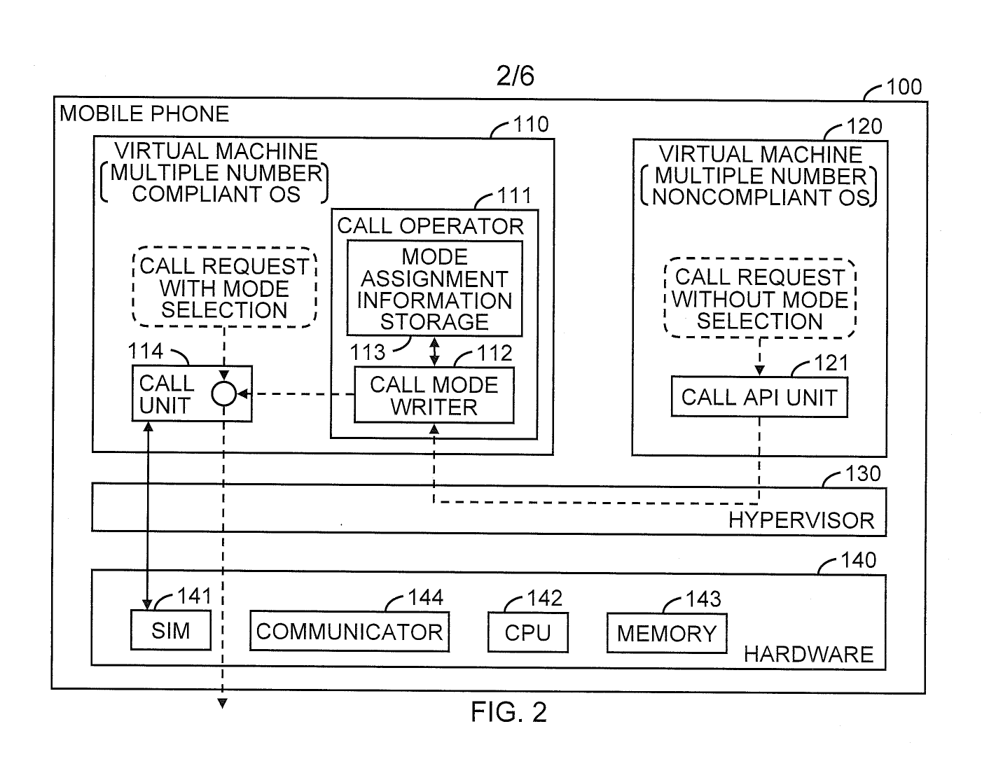

FIG. 2 illustrates an exemplary configuration of a mobile phone according to a first embodiment.

Referring to FIG. 2, the mobile phone 100 is compliant with a multiple phone number service provided by a carrier and corresponds to the mobile phone 10 illustrated in FIG. 1. The mobile phone 100 uses a virtualization technology implemented on a computer thereof. The mobile phone 100 includes a virtual machine 110, a virtual machine 120, a hypervisor 130, and hardware 140.

The hardware 140 of the computer of the mobile phone 100 includes, for example, a subscriber identity module (SIM) 141, a central processing unit (CPU) 142, a memory 143, such as a random access memory (RAM) or a read only memory (ROM), and a communicator 144 for external communication. The CPU 142 included in the computer of the mobile phone 100 executes software programs to perform functions of the virtual machine 110, the virtual machine 120, and the hypervisor 130.

The SIM 141 is a device in which the main phone number is stored. An SIM card is, for example, an integrated circuit (IC) card in which a unique identifier (ID) for identifying the phone number of the mobile phone is stored. In the present embodiment, the main number “090-AAA-AAAA” is stored in the SIM 141.

As illustrated in to FIG. 2, the mobile phone 100 according to the present embodiment includes two virtual machines, i.e., the virtual machines 110 and 120. The hypervisor 130 manages and controls the two virtual machines running on the mobile phone 100.

The virtual machine 110 is based on a closed mobile phone OS specific to the carrier associated with the mobile phone 100. The OS of the virtual machine 110 is a multiple number compliant OS which is compliant with the multiple phone number service provided by the carrier. The virtual machine 110 includes a user interface whereby a user may select a call mode to make a call.

The virtual machine 120 is based on an open mobile phone OS whose source code is open to public inspection. The OS of the virtual machine 120 is a multiple number noncompliant OS which is noncompliant with the multiple phone number service provided by the carrier. The virtual machine 120 includes a user interface whereby the user may make a call. However, the user is not allowed to select a call mode through the user interface in the virtual machine 120.

The virtual machine 110 based on the multiple number compliant OS includes a call operator 111 and a call unit 114. The virtual machine 120 based on the multiple number noncompliant OS includes a call application programming interface (API) unit 121.

In the virtualization technology, when the only one resource in an apparatus is shared across a plurality of OSs, requests to the resource are collected in one portion and processed under proper control, e.g., exclusive control. According to the present embodiment, the call unit 114 which performs external call control using the communicator 144 in the hardware 140 is disposed only in the virtual machine 110 based on the multiple number compliant OS. The call unit 114 is disposed on the virtual machine 110 based on the closed mobile phone OS specific to the carrier in order to perform call control compliant with the multiple phone number service provided by the carrier.

To allow the virtual machine 120 to use a call function provided by the call unit 114 in the virtual machine 110, a call sharing mechanism for allowing the call function to be shared is disposed in each of the virtual machines 110 and 120. The virtual machine 120 includes the call API unit 121 as a front-end call sharing mechanism. The call API unit 121 converts a call request received through a call API from functions of the OS of the virtual machine 120 into a call request in communication (hereinafter, referred to as inter-VM communication) between virtual machines and transmits the converted call request to the call operator 111 in the virtual machine 110. The virtual machine 110 includes the call operator 111 as a back-end call sharing mechanism. The call operator 111 converts the call request in inter-VM communication received from the call API unit 121 in the virtual machine 120 into a call request for the call unit 114 and passes the call request to the call unit 114.

When the user performs a call operation on the virtual machine 120, a call request issued in the virtual machine 120 is transmitted from the call API unit 121 in the virtual machine 120 to the call operator 111 in the virtual machine 110. The call operator 111 in the virtual machine 110 passes the call request received from the virtual machine 120 to the call unit 114. The call unit 114 performs call control in response to the call request received from the call operator 111.

Since the OS of the virtual machine 120 is the multiple number noncompliant OS, the user is not allowed to select a caller number from the plurality of phone numbers through the user interface in the virtual machine 120. Accordingly, the mode information specifying a call mode indicating a caller number is not inserted into the call request issued in the virtual machine 120. The call unit 114 performs a call using the main number “090-AAA-AAAA” as the caller number in response to the call request without the mode information. If call requests, including no mode information, issued in the virtual machine 120 are passed as they are to the call unit 114, all of calls from the virtual machine 120 are performed using the main number “090-AAA-AAAA” as the caller number. Disadvantageously, the virtual machine 120 may not be allowed to use the sub-number “090-BBB-BBBB” which is available in the multiple phone number service.

According to the present embodiment, in order to allow the virtual machine 120 based on the multiple number noncompliant OS to perform a call using the sub-number “090-BBB-BBBB” as the caller number, the call operator 111 in the virtual machine 110 is allowed to have a function for inserting a proper mode information into the call request. The call operator 111 includes a call mode writer 112 and a mode assignment information storage 113 so as to insert proper mode information into a call request.

The call mode writer 112 inserts mode information specifying a call mode indicating a caller number into a call request received by the call operator 111 in accordance with mode assignment information stored in the mode assignment information storage 113. The mode assignment information storage 113 is a computer-accessible memory and stores mode assignment information indicating an assigned call mode related to a virtual machine.

The call operator 111 inserts a proper mode information into the call request received from the virtual machine 120 based on the multiple number noncompliant OS using the call mode writer 112 and the mode assignment information storage 113 and passes the call request including the mode information to the call unit 114. Thus, according to the present embodiment, even the virtual machine 120 based on the multiple number noncompliant OS may be allowed to make a call using the sub-number “090-BBB-BBBB”.

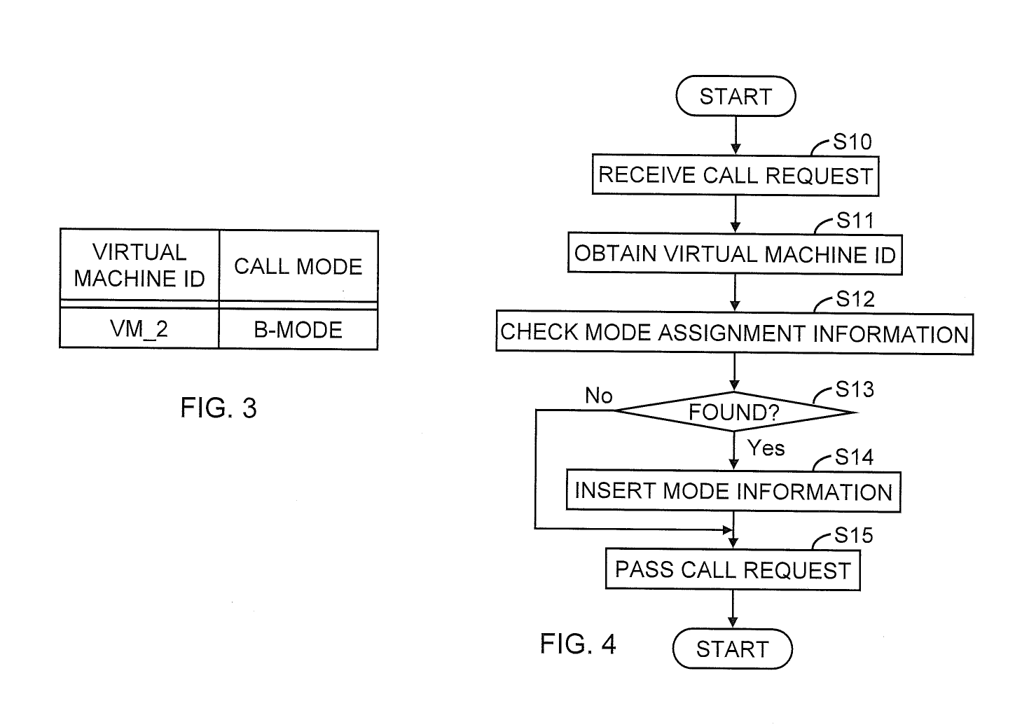

FIG. 3 illustrates an example of mode assignment information according to the present embodiment.

The mode assignment information according to the present embodiment illustrated in FIG. 3 is an example of information indicating a call mode related to a virtual machine, which is stored in the mode assignment information storage 113 in the call operator 111 included in the virtual machine 110 illustrated in FIG. 2. As illustrated in FIG. 3, the mode assignment information according to the present embodiment indicates the relationship between virtual machine ID, serving as identification information for uniquely identifying a virtual machine running on the mobile phone 100, and the relevant call mode indicating a caller number.

In the present embodiment, it is assumed that the virtual machine ID of the virtual machine 110 is “VM_1” and that of the virtual machine 120 is “VM_2”. It is also assumed that the virtual machine 120 based on the multiple number noncompliant OS is set to a virtual machine used only for a call using the sub-number “090-BBB-BBBB”. In this case, as illustrated in FIG. 3, the mode assignment information stored in the mode assignment information storage 113 indicates the relationship between the virtual machine ID “VM_2” of the virtual machine 120 and the call mode “B-mode” indicating a call using the sub-number “090-BBB-BBBB”.

The mode assignment information illustrated in FIG. 3 does not include information indicating a call mode related to the virtual machine 110. The reason is as follows. The OS of the virtual machine 110 is the multiple number compliant OS and the call unit 114 is provided for the virtual machine 110. As illustrated in FIG. 2, therefore, a call request issued in the virtual machine 110 is directly passed to the call unit 114 without being passed through the call operator 111.

In some cases, “not_assigned” (not illustrated in FIG. 3) is specified as a call mode related to a virtual machine ID of, for example, a virtual machine based on the multiple number compliant OS in the mode assignment information. The reason is as follows. In the virtual machine based on the multiple number compliant OS, a sub-number may be selected as a caller number. It is therefore unnecessary for the call mode writer 112 to insert mode information specifying a call mode indicating the sub-number into the call request. For instance, if a virtual machine based on the multiple number compliant OS exists as a third virtual machine, “not_assigned” is specified as a call mode related to the virtual machine ID of the third virtual machine.

FIG. 4 illustrates an exemplary operation flow of a mode information insertion process performed by the call mode writer according to the present embodiment.

The call mode writer 112 receives a call request (operation S10). The call mode writer 112 obtains a virtual machine ID of a virtual machine that has transmitted the call request (operation S11). For example, the virtual machine ID may be obtained via inter-VM communication. The virtual machine that has transmitted the call request may insert its own virtual machine ID into the call request and transmit the resultant call request.

The call mode writer 112 checks mode assignment information stored in the mode assignment information storage 113 (operation S12). The call mode writer 112 determines whether the mode assignment information includes information indicating a call mode to be specified in the call request (operation S13). When the mode assignment information does not include information indicating a call mode to be specified (“No” in operation S13), the call mode writer 112 advances the process to operation S15.

When the mode assignment information includes information indicating a call mode to be specified (“Yes” in operation S13), the call mode writer 112 inserts mode information specifying the call mode obtained from the mode assignment information into the call request received from the virtual machine (operation S14). The call mode writer 112 passes the call request to the call unit 114 (operation S15).

An exemplary call process of the mobile phone 100 according to the present embodiment will be discussed below with reference to FIG. 2.

It is assumed that the user makes a call to the destination phone 30 whose phone number is “090-XXX-XXXX” through the virtual machine 110 on the mobile phone 100. In this case, since the OS of the virtual machine 110 is the multiple number compliant OS, the user may freely select a call mode to make a call. When the user wants to use the main number “090-AAA-AAAA” as a caller number, the user selects the “A-mode” to make a call. When the user wants to use the sub-number “090-BBB-BBBB” as a caller number, the user selects the “B-mode” to make a call.

The call request issued in the virtual machine 110 includes mode information specifying the call mode selected by the user. In the virtual machine 110, the call request, including the mode information specifying the call mode selected by the user, for a call to the destination number “090-XXX-XXXX” is passed to the call unit 114.

The call unit 114 obtains the main number “090-AAA-AAAA” from the SIM 141. The call unit 114 generates a call signal, including mode information included in the call request, for a call from the main number “090-AAA-AAAA” to the destination number “090-XXX-XXXX”. The call unit 114 outputs the generated call signal by using the communicator 144 in the hardware 140.

It is assumed that the user makes a call to the destination phone 30 whose phone number is “090-XXX-XXXX” through the virtual machine 120 on the mobile phone 100. In this case, since the OS of the virtual machine 120 is the multiple number noncompliant OS, the user is not allowed to select a call mode to make a call.

The call request issued in the virtual machine 120 does not include mode information specifying the call mode. In the virtual machine 120, the call API unit 121 transmits a call request, including no mode information, for a call to the destination number “090-XXX-XXXX” to the call operator 111 in the virtual machine 110 via the hypervisor 130.

In the call operator 111 in the virtual machine 110, the call mode writer 112 receives the call request from the virtual machine 120. The call mode writer 112 obtains the virtual machine ID “VM_2” of the virtual machine 120. The call mode writer 112 checks the mode assignment information, illustrated in FIG. 3, stored in the mode assignment information storage 113, thereby obtaining the “B-mode” as a call mode related to the virtual machine 120 on the basis of the obtained virtual machine ID “VM_2”. The call mode writer 112 inserts the obtained call mode “B-mode” into the call request received from the virtual machine 120. The call mode writer 112 passes the call request including mode information specifying the call mode “B-mode” for a call to the destination number “090-XXX-XXXX” to the call unit 114.

The call unit 114 obtains the main number “090-AAA-AAAA” from the SIM 141. The call unit 114 generates a call signal, including mode information specifying the “B-mode” included in the call request, for a call from the main number “090-AAA-AAAA” to the destination number “090-XXX-XXXX”. The call unit 114 outputs the generated call signal by using the communicator 144 in the hardware 140.

As discussed above, in the mobile phone 100 according to the first embodiment, a call using the sub-number “090-BBB-BBBB” available in the multiple phone number service may be performed even by the virtual machine 120 based on the multiple number noncompliant OS. Accordingly, the mounted multiple phone number service specific to the carrier may be used by functions of an open mobile phone OS, thus increasing the convenience of the user using the mobile phone 100.

### Second Embodiment

In the above-discussed first embodiment, the function for inserting mode information into a call request issued in a virtual machine based on the multiple number noncompliant OS is provided in a virtual machine, having the call function, based on the multiple number compliant OS.

A second embodiment relates to a case where a function for inserting mode information into a call request is provided in a virtual machine based on a multiple number noncompliant OS.

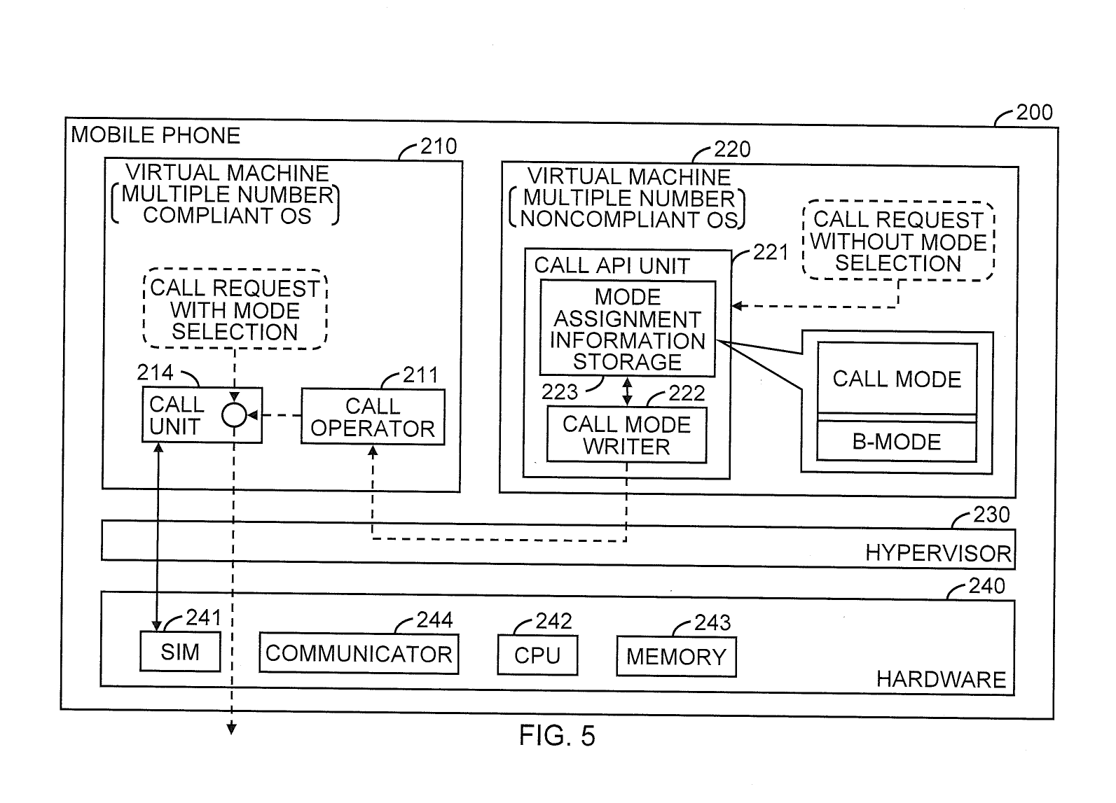

FIG. 5 illustrates an exemplary configuration of a mobile phone according to the present embodiment.

Referring to FIG. 5, the mobile phone 200 is compliant with a multiple phone number service provided by a carrier in a manner similar to the mobile phone 100 illustrated in FIG. 2 and corresponds to the mobile phone 10 illustrated in FIG. 1. The mobile phone 100 uses a virtualization technology implemented on a computer thereof. The mobile phone 200 includes a virtual machine 210, a virtual machine 220, a hypervisor 230, and hardware 240.

The hardware 240 of the computer of the mobile phone 200 includes, for example, an SIM 241, a CPU 242, a memory 243, and a communicator 244. The CPU 242 included in the computer of the mobile phone 200 executes software programs to perform functions of the virtual machine 210, the virtual machine 220, and the hypervisor 230. The hypervisor 230 manages and controls the two virtual machines running on the mobile phone 200.

The virtual machine 210 on the mobile phone 200 corresponds to the virtual machine 110 on the mobile phone 100 illustrated in FIG. 2. The virtual machine 210 is based on a closed mobile phone OS specific to the carrier associated with the mobile phone 200. The OS of the virtual machine 210 is a multiple number compliant OS which is compliant with the multiple phone number service provided by the carrier. The virtual machine 210 includes a user interface whereby a user may select a call mode to make a call. Similar to the virtual machine 110 illustrated in FIG. 2, the virtual machine 210 includes a call operator 211 and a call unit 214. However, unlike the call operator 111 in virtual machine 110 illustrated in FIG. 2, the call operator 211 in the virtual machine 210 does not include a function for inserting mode information into a call request received from another virtual machine.

The virtual machine 220 on the mobile phone 200 corresponds to the virtual machine 120 on the mobile phone 100 illustrated in FIG. 2. The virtual machine 220 is based on an open mobile phone OS whose source code is open to public inspection. The OS of the virtual machine 220 is a multiple number noncompliant OS which is noncompliant with the multiple phone number service provided by the carrier. The virtual machine 220 includes a user interface whereby the user may make a call. However, the user is not allowed to select a call mode through the user interface in the virtual machine 220. Similar to the virtual machine 120 illustrated in FIG. 2, the virtual machine 220 includes a call API unit 221. However, unlike the call API unit 121 in the virtual machine 120 illustrated in FIG. 2, the call API unit 221 in the virtual machine 220 includes a call mode writer 222 and a mode assignment information storage 223 so as to insert mode information into a call request.

The call mode writer 222 inserts mode information specifying a call mode indicating a caller number into a call request issued in the virtual machine 220 in accordance with mode assignment information stored in the mode assignment information storage 223. The mode assignment information storage 223 is a computer-accessible memory and stores mode assignment information indicating an assigned call mode related to the virtual machine 220.

As illustrated in FIG. 5, according to the present embodiment, the mode assignment information includes only the call mode related to the virtual machine 220 itself. In this case, it is assumed that the virtual machine 220 based on the multiple number noncompliant OS is set to a virtual machine used only for a call using the sub-number “090-BBB-BBBB”. As illustrated in FIG. 5, the “B-mode” indicating a call using the sub-number “090-BBB-BBBB” is recorded as the call mode related to the virtual machine 220 in the mode assignment information.

A mode information insertion process performed by the call mode writer 222 in the present embodiment is equivalent to a process obtained by removing the operation of obtaining the virtual machine ID in operation S11 from the mode information insertion process illustrated in FIG. 4 performed by the call mode writer 112 in the above-discussed first embodiment. In the mode information insertion process performed by the call mode writer 222, mode information specifying the call mode recorded in the mode assignment information stored in the mode assignment information storage 223 is inserted into the call request in operation S14 in FIG. 4.

The call API unit 221 inserts a proper mode information into the call request issued in the virtual machine 220 using the call mode writer 222 and the mode assignment information storage 223 and transmits the call request including the mode information to the call operator 211 in the virtual machine 210.

The call operator 211 in the virtual machine 210 passes the call request, including the mode information, received from the virtual machine 220 as it is to the call unit 214. Thus, according to the present embodiment, even the virtual machine 220 based on the multiple number noncompliant OS may be allowed to make a call using the sub-number “090-BBB-BBBB”.

An exemplary call process of the mobile phone 200 according to the present embodiment will be discussed below with reference to FIG. 5.

The call process through the virtual machine 210 based on the multiple number compliant OS is the same as that through the virtual machine 110 in FIG. 2.

It is assumed that the user makes a call to the destination phone 30 whose phone number is “090-XXX-XXXX” through the virtual machine 220 on the mobile phone 200. In this case, since the OS of the virtual machine 220 is the multiple number noncompliant OS, the user is not allowed to select a call mode to make a call.

An original call request issued in the virtual machine 220 does not include mode information specifying a call mode. In the call API unit 221 in the virtual machine 220, the call mode writer 222 receives the original call request issued in the virtual machine 220. The call mode writer 222 checks the mode assignment information, illustrated in FIG. 5, stored in the mode assignment information storage 223 and obtains the “B-mode” as a call mode related to the virtual machine 220. The call mode writer 222 inserts mode information specifying the obtained call mode “B-mode” into the original call request issued in the virtual machine 220. The call mode writer 222 transmits the call request including the mode information specifying the call mode “B-mode” for a call to the destination number “090-XXX-XXXX” to the call operator 211 in the virtual machine 210.

The call operator 211 in the virtual machine 210 passes the call request including the mode information specifying the call mode “B-mode” for a call to the destination number “090-XXX-XXXX”, received from the virtual machine 220, to the call unit 214.

The call unit 214 obtains the main number “090-AAA-AAAA” from the SIM 241. The call unit 214 generates a call signal, including mode information specifying the “B-mode” included in the call request, for a call from the main number “090-AAA-AAAA” to the destination number “090-XXX-XXXX”. The call unit 214 outputs the generated call signal by using the communicator 244 in the hardware 240.

As discussed above, in the mobile phone 200 according to the second embodiment, a call using the sub-number “090-BBB-BBBB” available in the multiple phone number service may be performed even by the virtual machine 220 based on the multiple number noncompliant OS. Accordingly, the mounted multiple phone number service specific to the carrier may be used by functions of the open mobile phone OS, thus increasing the convenience of the user using the mobile phone 200.

### Third Embodiment

A third embodiment relates to a case where a virtual machine that includes no user interface for call operation is allowed to have a call function and a function for inserting mode information specifying a call mode into a call request received from other virtual machine.

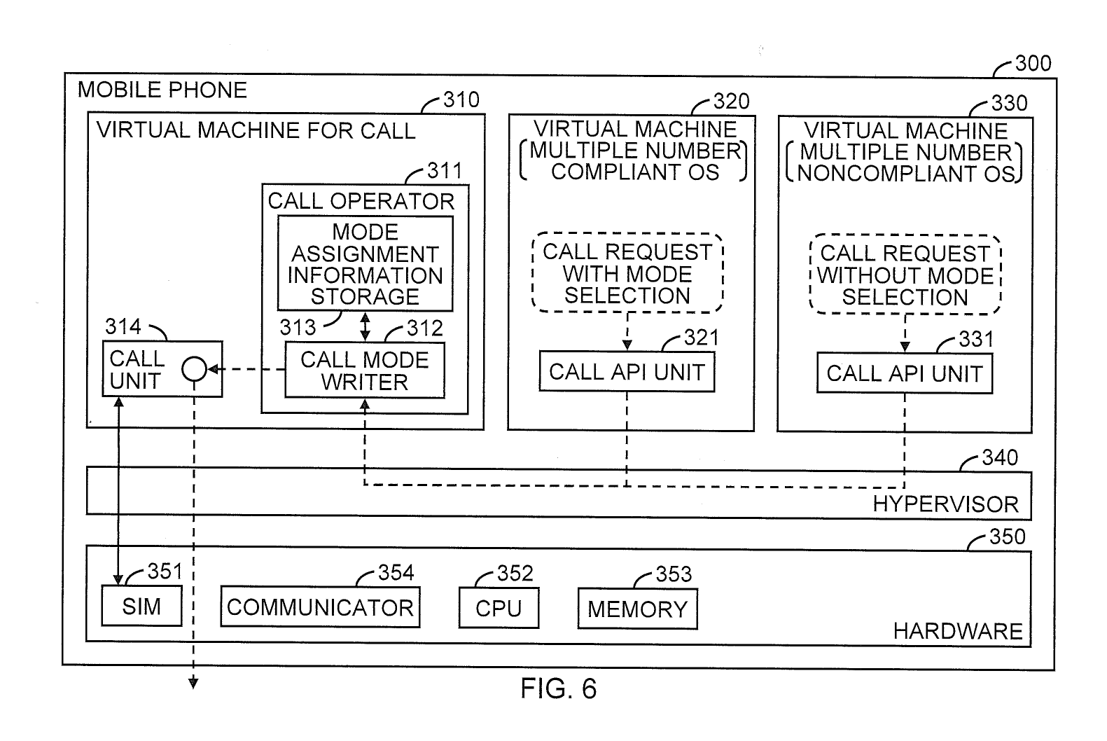

FIG. 6 illustrates an exemplary configuration of a mobile phone according to the present embodiment.

Referring to FIG. 6, the mobile phone 300 is compliant with a multiple phone number service provided by a carrier in a manner similar to the mobile phone 100 illustrated in FIG. 2 and corresponds to the mobile phone 10 illustrated in FIG. 1. The mobile phone 300 uses a virtualization technology implemented on a computer thereof. The mobile phone 300 includes a virtual machine 310 (hereinafter, referred to as “call-function virtual machine 310”) for calling, a virtual machine 320, a virtual machine 330, a hypervisor 340, and hardware 350.

The hardware 350 of the computer of the mobile phone 300 includes, for example, an SIM 351, a CPU 352, a memory 353, and a communicator 354. The CPU 352 included in the computer of the mobile phone 300 executes software programs to perform functions the call-function virtual machine 310, the virtual machine 320, the virtual machine 330, and the hypervisor 340. The hypervisor 340 manages and controls the three virtual machines running on the mobile phone 300.

The virtual machine 320 on the mobile phone 300 corresponds to the virtual machine 110 on the mobile phone 100 illustrated in FIG. 2. The virtual machine 320 is based on a closed mobile phone OS specific to the carrier associated with the mobile phone 300. The OS of the virtual machine 320 is a multiple number compliant OS which is compliant with the multiple phone number service provided by the carrier. The virtual machine 320 includes a user interface whereby a user may select a call mode to make a call. However, unlike the virtual machine 110 illustrated in FIG. 2, the virtual machine 320 does not include a call unit. Accordingly, the virtual machine 320 includes a call API unit 321 as a front-end call sharing mechanism.

The virtual machine 330 on the mobile phone 300 corresponds to the virtual machine 120 on the mobile phone 100 illustrated in FIG. 2. The virtual machine 330 is based on an open mobile phone OS whose source code is open to public inspection. The OS of the virtual machine 330 is a multiple number noncompliant OS which is noncompliant with the multiple phone number service provided by the carrier. The virtual machine 330 includes a user interface whereby the user may make a call. However, the user is not allowed to select a call mode through the user interface in the virtual machine 330. The virtual machine 330 includes a call API unit 331 in a manner similar to the virtual machine 120 illustrated in FIG. 2.

The call-function virtual machine 310 on the mobile phone 300 includes no user interface for call operation and is specialized in external call control. In the present embodiment, therefore, the call-function virtual machine 310 is provided with a call unit 314. Since the call-function virtual machine 310 includes the call unit 314, the call-function virtual machine 310 also includes a call operator 311 as a back-end call sharing mechanism.

The call unit 314 controls calls compliant with the multiple phone number service provided by the carrier. The virtual machine 310 is based on a closed mobile phone OS specific to the carrier associated with the mobile phone 300. The OS of the virtual machine 310 including the call unit 314 is a multiple number compliant OS which is compliant with the multiple phone number service provided by the carrier. In other words, the call-function virtual machine 310 is a virtual machine based on the multiple number compliant OS but includes no user interface for call operation.

The call operator 311 in the call-function virtual machine 310 has a function for inserting a proper mode information into a call request. The call operator 311 includes a call mode writer 312 and a mode assignment information storage 313 so as to insert a proper mode information into a call request.

The call mode writer 312 inserts mode information specifying a call mode indicating a caller number into a call request received by the call operator 311 in accordance with mode assignment information stored in the mode assignment information storage 313. The mode assignment information storage 313 is a computer-accessible memory and stores mode assignment information indicating an assigned call mode related to a virtual machine.

The call operator 311 inserts a proper mode information into the call request received from the virtual machine 330 based on the multiple number noncompliant OS using the call mode writer 312 and the mode assignment information storage 313 and passes the call request including the mode information to the call unit 314. Thus, according to the third embodiment, even the virtual machine 330 based on the multiple number noncompliant OS may be allowed to make a call using the sub-number “090-BBB-BBBB”.

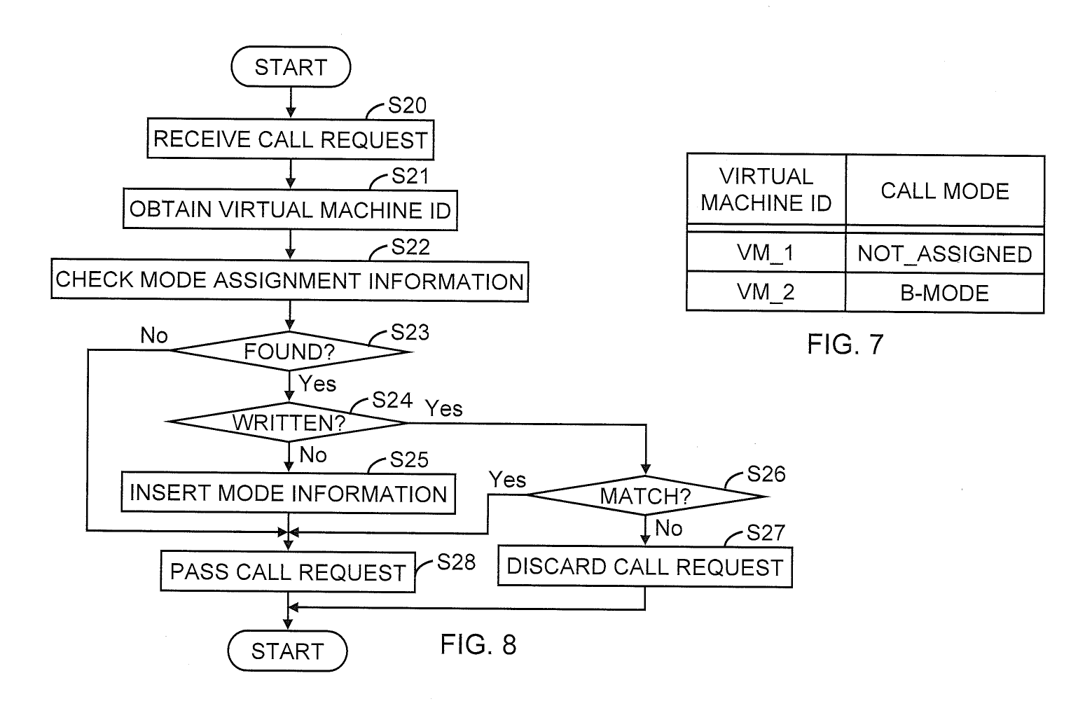

FIG. 7 illustrates an example of mode assignment information according to the present embodiment.

The mode assignment information according to the present embodiment illustrated in FIG. 7 is an example of information indicating a call mode related to each virtual machine, which is stored in the mode assignment information storage 313 in the call operator 311 included in the call-function virtual machine 310 illustrated in FIG. 6. As illustrated in FIG. 7, the mode assignment information in the present embodiment indicates the relationship between each virtual machine ID, serving as identification information for uniquely identifying a virtual machine running on the mobile phone 300, and the relevant call mode indicating a caller number. In the present embodiment, it is assumed that the virtual machine ID of the virtual machine 320 is “VM_1” and that of the virtual machine 330 is “VM_2”.

Since the OS of the virtual machine 320 is the multiple number compliant OS, the user may select the sub-number on the virtual machine 320 and a call request transmitted from the virtual machine 320 may include mode information specifying the call mode selected by the user. Accordingly, in the mode assignment information stored in the mode assignment information storage 313, a call mode for “VM_1” is “not_assigned” indicating that a call mode is not assigned to the virtual machine ID “VM_1” of the virtual machine 320.

It is assumed that the virtual machine 330 based on the multiple number noncompliant OS is set to a virtual machine used only for a call using the sub-number “090-BBB-BBBB”. In this case, as illustrated in FIG. 7, the mode assignment information stored in the mode assignment information storage 313 includes information indicating the relationship between the virtual machine ID “VM_2” of the virtual machine 330 and the call mode “B-mode” indicating a call using the sub-number “090-BBB-BBBB”.

The mode information insertion process performed by the call mode writer 312 in the present embodiment is the same as that, illustrated in FIG. 4, performed by the call mode writer 112 in the foregoing first embodiment.

An exemplary call process of the mobile phone 300 according to the present embodiment will be discussed below with reference to FIG. 6.

It is assumed that the user makes a call to the destination phone 30 whose phone number is “090-XXX-XXXX” through the virtual machine 320 on the mobile phone 300. In this case, since the OS of the virtual machine 320 is the multiple number compliant OS, the user may freely select a call mode to make a call. When the user wants to use the main number “090-AAA-AAAA” as a caller number, the user selects the “A-mode” to make a call through the virtual machine 320. When the user wants to use the sub-number “090-BBB-BBBB” as a caller number, the user selects the “B-mode” to make a call through the virtual machine 320.

The call request issued in the virtual machine 320 includes mode information specifying the call mode selected by the user. The call API unit 321 in the virtual machine 320 transmits the call request, including the mode information specifying the call mode selected by the user, for a call to the destination number “090-XXX-XXXX” to the call operator 311 in the call-function virtual machine 310 via the hypervisor 340.

In the call operator 311 in the call-function virtual machine 310, the call mode writer 312 receives the call request from the virtual machine 320. The call mode writer 312 obtains the virtual machine ID “VM_1” of the virtual machine 320. The call mode writer 312 checks the mode assignment information, illustrated in FIG. 7, stored in the mode assignment information storage 313 and detects absence (“not_assigned”) of a call mode on the basis of the obtained virtual machine ID “VM_1”. The call mode writer 312 passes the call request received from the virtual machine 320, which includes the mode information specifying the call mode selected by the user, for a call to the destination number “090-XXX-XXXX” to the call unit 314.

The call unit 314 obtains the main number “090-AAA-AAAA” from the SIM 351. The call unit 314 generates a call signal, including the mode information included in the call request, for a call from the main number “090-AAA-AAAA” to the destination number “090-XXX-XXXX”. The call unit 314 outputs the generated call signal by using the communicator 354 in the hardware 350.

A call process through the virtual machine 330 based on the multiple number noncompliant OS is the same as that through the virtual machine 120 in FIG. 2, except that the destination of the call request is the call-function virtual machine 310.

According to the present embodiment, the OS of the call-function virtual machine 310 is the closed mobile phone OS which is compliant with the multiple phone number service and is specific to the carrier. The other virtual machines each including the user interface for call operation may be virtual machines based on the open multiple number noncompliant OS.

As discussed above, in the mobile phone 300 according to the third embodiment, a call using the sub-number “090-BBB-BBBB” available in the multiple phone number service may be performed even by the virtual machine 330 based on the multiple number noncompliant OS. Accordingly, the mounted multiple phone number service specific to the carrier may be used by functions of the open mobile phone OS, thus increasing the convenience of the user using the mobile phone 300.

In the foregoing first embodiment and the third embodiment, the function for inserting mode information into a call request is provided in the virtual machine based on the closed mobile phone OS which is compliant with the multiple phone number service and is specific to the carrier. In such a case, it is unnecessary to install classified information of the carrier into the open mobile phone OS. Advantageously, the security of the carrier may be ensured. If the function for inserting mode information into a call request is provided for a virtual machine based on the open mobile phone OS in a manner similar to the foregoing second embodiment, classified information of the carrier may not be held.

### Fourth Embodiment

A fourth embodiment relates to a case where when mode information specifying a call mode other than that recorded in the mode assignment information is included in a call request, the mode information included in the call request is rewritten or the call request is rejected during a process of inserting mode information into the call request.

When a call request received from a virtual machine based on the multiple number noncompliant OS includes mode information specifying a call mode other than that recorded in the mode assignment information, invalid mode information insertion may be caused, for example, by illegally tampering with a program. According to the present embodiment, the mode information included in the call request may be rewritten or the call request may be discarded when the mode information specifies a call mode other than that recorded in the mode assignment information, thus preventing incorrect billing.

A process according to the present embodiment will be discussed with reference to FIG. 2, using the mobile phone 100 which has been discussed in the foregoing first embodiment.

FIG. 8 illustrates an exemplary operation flow of a mode information insertion process performed by the call mode writer according to the present embodiment.

The call mode writer 112 receives a call request (operation S20). The call mode writer 112 obtains a virtual machine ID of a virtual machine that has transmitted the call request (operation S21).

The call mode writer 112 checks mode assignment information stored in the mode assignment information storage 113 (operation S22). The call mode writer 112 determines whether the mode assignment information includes information indicating a call mode to be specified in the call request (operation S23).

When the mode assignment information does not include information indicating a call mode to be specified (“No” in operation S23), the call mode writer 112 passes the call request received from the virtual machine as it is to the call unit 114 (operation S28).

When the mode assignment information includes information indicating a call mode to be specified (“Yes” in operation S23), the call mode writer 112 determines whether the call request received from the virtual machine includes mode information (operation S24).

When the call request received from the virtual machine does not include any mode information (“No” in operation S24), the call mode writer 112 inserts mode information specifying the call mode recorded in the mode assignment information into the call request received from the virtual machine (operation S25). The call mode writer 112 passes the resultant call request to the call unit 114 (operation S28).

When the call request received from the virtual machine includes mode information (“Yes” in operation S24), the call mode writer 112 determines whether the call mode specified by the mode information included in the call request matches the call mode recorded in the mode assignment information stored in the mode assignment information storage 113 (operation S26).

When the call mode specified by the mode information included in the call request matches the call mode recorded in the mode assignment information (“Yes” in operation S26), the call mode writer 112 passes the call request received from the virtual machine as it is to the call unit 114 (operation S28).

When the call mode specified by the mode information included in the call request does not match the call mode recorded in the mode assignment information (“No” in operation S26), the call mode writer 112 discards the call request received from the virtual machine (operation S27). Instead of discarding the call request, the call mode writer 112 may overwrite the mode information included in the call request with mode information specifying the call mode recorded in the mode assignment information when the call mode specified by the mode information included in the call request is different from the call mode recorded in the mode assignment information.

An exemplary call process of the mobile phone 100 according to the present embodiment will be discussed with reference to FIG. 2.

It is assumed that a user makes a call to the destination phone 30 whose phone number is “090-XXX-XXXX” through the virtual machine 120 on the mobile phone 100. In this case, since the OS of the virtual machine 120 is the multiple number noncompliant OS, the user is not allowed to select a call mode to make a call. In other words, normally, a call request from the virtual machine 120 does not include mode information. In this case, however, it is assumed that the mode information specifying the “A-mode” indicating a call using the main number “090-AAA-AAAA” is inserted into the call request by executing any unauthorized program.

In the virtual machine 120, the call API unit 121 transmits the call request including mode information specifying the “A-mode” as a call mode, for a call to the destination number “090-XXX-XXXX” to the call operator 111 in the virtual machine 110 through the hypervisor 130.

In the call operator 111 in the virtual machine 110, the call mode writer 112 receives the call request from the virtual machine 120. The call mode writer 112 obtains the virtual machine ID “VM_2” of the virtual machine 120. The call mode writer 112 checks the mode assignment information, illustrated in FIG. 3, stored in the mode assignment information storage 113, thereby obtaining the “B-mode” as a call mode related to the virtual machine 120 on the basis of the obtained virtual machine ID “VM_2”.

The call mode writer 112 detects that the call request received from the virtual machine 120 includes mode information specifying the call mode “A-mode”. Since the call mode related to the virtual machine ID “VM_2” of the virtual machine 120 is the “B-mode” according to the mode assignment information of FIG. 3, the call mode writer 112 determines that the call request, including mode information specifying the call mode “A-mode”, received from the virtual machine 120 is abnormal. The call mode writer 112 discards the call request received from the virtual machine 120, which is determined to be abnormal.

The mode information included in the call request determined as abnormal may be rewritten with correct mode information. In this case, the call mode writer 112 overwrites the mode information, specifying the call mode “A-mode”, included in the call request received from the virtual machine 120 with mode information specifying the call mode “B-mode” recorded in the mode assignment information of FIG. 3 and passes the resultant call request to the call unit 114.

As discussed above, in the mobile phone 100 according to the fourth embodiment, even when a call request received from the virtual machine 120 based on the multiple number noncompliant OS includes invalid mode information, a call in the invalid call mode may be prevented. Thus, unintended billing may be prevented.

### Fifth Embodiment

A fifth embodiment relates to a case where during a process of inserting mode information into a call request, a virtual machine related to a call mode specified by the mode information included in the call request passed to a call unit is allowed to receive notification that a call in the call mode has been performed.

For example, in each virtual machine, call history related to a caller number used in the virtual machine may be managed in a storage unit (not illustrated). In this case, assuming that the caller number available in the virtual machine is used in a call through another virtual machine, if the virtual machine does not know the call, the virtual machine may not present correct call history to a user when the user refers to the call history relevant to the phone number on the virtual machine. In consideration of such a situation, according to the present embodiment, notification that a call has been performed through a virtual machine having a function for inserting mode information into a call request is transmitted to another virtual machine through which a call may be performed using the same phone number.

A process according to the present embodiment will be discussed with reference to FIG. 6, using the mobile phone 300 which has been discussed in the foregoing third embodiment.

According to the present embodiment, the call mode writer 312 passes a call request to the call unit 314 and then checks mode assignment information stored in the mode assignment information storage 313 to obtain the virtual machine ID of a virtual machine related to a call mode specified by the mode information included in the call request passed to the call unit 314. The call mode writer 312 notifies a virtual machine related to the obtained virtual machine ID that a call in the call mode specified by the mode information included in the call request passed to the call unit 314 has been performed. The notified virtual machine performs, for example, a process of updating call history.

An exemplary call process of the mobile phone 300 according to the present embodiment will be discussed below with reference to FIG. 6.

It is assumed that a user makes a call to the destination phone 30 whose phone number is “090-XXX-XXXX” through the virtual machine 320 on the mobile phone 300. Since the OS of the virtual machine 320 is the multiple number compliant OS, the user may freely select a call mode to make a call. In this case, the user selects the “B-mode” indicating a call using the sub-number “090-BBB-BBBB” to make a call through the virtual machine 320.

A call request received from the virtual machine 320 includes mode information specifying the “B-mode” as a call mode. The call API unit 321 in the virtual machine 320 transmits the call request including mode information specifying the call mode “B-mode” for a call to the destination number “090-XXX-XXXX” to the call operator 311 in the call-function virtual machine 310 through the hypervisor 340.

In the call operator 311 in the call-function virtual machine 310, the call mode writer 312 receives the call request from the virtual machine 320. The call mode writer 312 obtains the virtual machine ID “VM_1” of the virtual machine 320. The call mode writer 312 checks the mode assignment information, illustrated in FIG. 7, stored in the mode assignment information storage 313 and detects absence (“not_assigned”) of a call mode on the basis of the obtained virtual machine ID “VM_1”. The call mode writer 312 passes the call request, received from the virtual machine 320 and including the mode information specifying the call mode “B-mode”, for a call to the destination number “090-XXX-XXXX” to the call unit 314.

At this time, the call mode writer 312 checks the mode assignment information, illustrated in FIG. 7, stored in the mode assignment information storage 313 to obtain the virtual machine ID related to the call mode “B-mode” specified by the mode information included in the call request passed to the call unit 314. In this case, a virtual machine related to “not_assigned” of a call mode recorded in the mode assignment information is also obtained as a virtual machine related to the call mode “B-mode”, since the virtual machine is based on the multiple number compliant OS. The call mode writer 312 checks the mode assignment information illustrated in FIG. 7 and obtains the virtual machine ID “VM_1” related to the virtual machine 320 and the virtual machine ID “VM_2” related to the virtual machine 330 as the virtual machine IDs related to the call mode “B-mode”. The call mode writer 312 notifies each of the virtual machine 320 related to the obtained virtual machine ID “VM_1” and the virtual machine 330 related to the obtained virtual machine ID “VM_2” through the hypervisor 340 that the call, in which the call mode “B-mode” has been specified, to the destination number “090-XXX-XXXX” has been performed. In this case, since the virtual machine 320 is a source of the call request, the notification to the request-source virtual machine 320 may be omitted.

For example, the call API unit 331 in the virtual machine 330 receives the notification from the call-function virtual machine 310 and records the call to the phone number “090-XXX-XXXX” in its own call history.

As discussed above, in the mobile phone 300 according to the fifth embodiment, a call through a virtual machine may be notified to another virtual machine which may perform a call using the same phone number. Consequently, a call performed through a virtual machine may be reflected in call history of another virtual machine which may perform a call using the same phone number, thus increasing the convenience of the user using the mobile phone 300.

The process performed by the mobile phone according to each of the above-discussed embodiments may be performed by the hardware, such as the CPU and the memory included in the computer, and the software program. The program may be recorded in a computer-readable recording medium or may be provided via a network.

In each of the embodiments, the number of virtual machines including a user interface that allows a call is two on the mobile phone. However, three or more virtual machines including a user interface that allows a call may be disposed on the mobile phone.

In the first embodiment, a call request issued in the virtual machine 110 including the call unit 114 is directly input to the call unit 114 without being passed through the call operator 111, as illustrated in FIG. 2. Actually, the call request in the virtual machine 110 including the call unit 114 may be passed through the call operator 111 to the call unit 114.

In each of the embodiments, the mobile phone has been discussed as an example of the communication apparatus that performs communication using a plurality of caller numbers. However, the technique relating to communication using a plurality of caller numbers according to the embodiments may be applied to another communication apparatus, e.g., a data communication apparatus that performs data communication.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A communication apparatus comprising:
a plurality of virtual machines including at least one virtual machine compliant with multiple caller number service and at least one virtual machine noncompliant with the multiple caller number service, wherein
one of the plurality of virtual machines includes:
a mode assignment information storage for storing mode assignment information indicating a call mode corresponding to each of the at least one virtual machine noncompliant with the multiple caller number service, the call mode indicating a caller number, and
a call mode writer configured to obtain, upon receiving a call request from another virtual machine among the plurality of virtual machines, the call mode corresponding to the another virtual machine from the mode assignment information storage to write mode information specifying the obtained call mode in the received call request.

2. The communication apparatus according to claim 1, wherein
the one of the plurality of virtual machines is one of the at least one virtual machine compliant with the multiple caller number service.

3. The communication apparatus according to claim 1, wherein
when mode information included in the received call request conflicts with the call mode corresponding to the another virtual machine, the call mode writer discards the received call request or rewrites the mode information included in the received call request with the mode information specifying the obtained call mode.

4. The communication apparatus according to claim 1, wherein
the call mode writer detects, in accordance with the mode assignment information stored in the mode assignment information storage, a virtual machine corresponding to the obtained call mode to notify the detected virtual machine of the call request.
